(19) United States
(12) Patent Application Publication
(10) Pub. No.: US 2005/0188410 A1
(43) Pub. Date: Aug. 25, 2005

(54) Methods and apparatus for switching from a non-module tuning mode to a module tuning mode in a cable television receiver

(76) Inventors: Michael Kahn, Westampton, NJ (US); Daniel Mocelo, Marlton, NJ (US); David Siegers, Morrisville, PA (US); Philip Reeves, Burlington, NJ (US); Edwin R. Meyer, Princeton, NJ (US)

Correspondence Address: RATNERPRESTIA, P O BOX 980, VALLEY FORGE, PA, 19482-0980, US

(21) Appl. No.: 10/783,104

(22) Filed: Feb. 20, 2004

(51) Int. Cl. H04N 7/173; H04N 5/50; H04N 7/16; G06F 13/00; H04N 5/445

(52) U.S. Cl. 725/100; 348/731; 725/37; 725/120; 725/131; 725/151

(57) ABSTRACT

A method and apparatus for switching a cable television receiver from a non-module tuning mode to a module tuning mode is disclosed. To switch from the non-module tuning mode to the module tuning mode, a cable tuning module is detected, module tuning data is acquired, and the cable television receiver is switched from the non-module tuning mode to the module tuning mode responsive to a measure of the acquired module tuning data.

### FIELD OF THE INVENTION

The present invention relates to the field of cable television receivers and, more particularly, to methods and apparatus for switching from a non-module tuning mode to a module tuning mode in cable television receivers having removable cable tuning modules.

### BACKGROUND OF THE INVENTION

Cable television systems provide subscribers with access to basic television programming and premium services such as premium channels, pay-per-view programming, video-on-demand programming, and Internet access. Subscribers are often required to have a cable television receiver that is compatible with the cable television system to access premium services. The cable television receiver processes signals received from the cable television system to provide the subscribers with the basic programming and premium services. Without the cable television receiver, subscribers are able only to access the basic programming channels. The cable television receiver may be incorporated into a television or may be contained in a box separate from the television, referred to herein as a set-top box.

Cable television systems employ security techniques to ensure that only subscribers who have paid for the premium services have access to them. For example, premium services, such as premium movie channels, may be scrambled before transmission to prevent unauthorized viewing of those channels. Subscribers who pay additional fees to receive the premium services are provided with the means to descramble and view the premium services. Descrambling circuitry is typically incorporated into the subscriber's cable television receiver to allow a subscriber who has paid for premium services to descrambled these services. Often cable television systems use proprietary algorithms to scramble and descramble services. The the proprietary algorithms may be periodically updated for security.

Presently, cable television receivers are available with module ports for receiving removable cable tuning modules. The removable cable tuning modules are commonly referred to as point-of-deployment (POD) modules. POD modules may contain cable television system compatibility circuitry and descrambling circuitry for tuning basic programming and premium services. The POD modules are easily exchanged when changing cable television systems or when updating proprietary algorithms used for scrambling/descrambling. In cable television systems following the OPENCABLE™ system of Cable Television Laboratories, Inc., Louisville, Colo., USA, the POD Module, referred to as a CABLECARD™, is implemented in a PCMCIA form factor.

A cable television receiver that supports an OPENCABLE™ POD module, may be used for tuning with or without the POD module. When not using the POD module for tuning, referred to herein as the non-module tuning mode, channels available with the cable television receiver are determined by setting a tuner to desired frequencies and detecting the presence of data at each of those frequencies. In the non-module tuning mode some or all of the basic programming channels are available, but not the premium services. When using the POD module for tuning, referred to herein as the module tuning mode, the cable television receiver may receive information about the available channels and services via the POD module. In the module tuning mode all basic programming and premium services are available.

POD modules may be inserted into a cable television receiver at any time, regardless of whether the cable television receiver is currently powered, in standby, or in a power-off state. When a POD module is inserted, its presence can be detected from electronic signals that become active when a POD module is present. Currently, when a POD module is detected, cable television receivers immediately enter the module tuning mode and begin collecting data for tuning basic programming and premium services. Considerable time may elapse, however, before sufficient data is collected from the cable television system to tune all available channels and services in the module mode using the POD module. Delay may result, for example, if the subscriber has not yet telephoned their local cable operator to activate the services provided by the POD module. It may then take several hours for distribution of the necessary information, e.g., using a “carousel” format of a National Autorization Service (NAS), to allow full access to all services.

In the module tuning mode, while collecting data for tuning, the cable television receiver may initially be able to tune to only a small number of channels (e.g., fewer channel than are tunable in the non-module mode) or may be non-functional. In addition, switching to the module tuning mode during this time may result in a channel that a viewer was tuned to in the non-module tuning mode being temporarily unavailable. Therefore, it may be desirable to initially remain in the non-module tuning mode rather than immediately transitioning to the module tuning mode upon detection of a POD module as in current cable television receivers. Accordingly, improved methods are needed for transitioning from a non-module tuning mode to a module tuning mode that are not subject to the above limitations. The present invention fulfills this need among others.

### SUMMARY OF THE INVENTION

The present invention is embodied in methods and apparatus for switching a cable television receiver from a non-module tuning mode to a module tuning mode. To switch from the non-module tuning mode to the module tuning mode, a cable tuning module is detected, module tuning data is acquired, and the cable television receiver is switched from the non-module tuning mode to the module tuning mode responsive to a measure of the acquired module tuning data.

### BRIEF DESCRIPTION OF THE DRAWINGS

The invention is best understood from the following detailed description when read in connection with the accompanying drawings, with like elements having the same reference numerals. Included in the drawings are the following figures:

FIG. 1 is a block diagram of an exemplary cable television receiver in accordance with the present invention.

FIG. 2 depicts a known structure for a Network Information Table.

FIG. 3 depicts a known structure for a Carrier Definition Sub-table record.

FIG. 4 depicts a known structure for a Modulation Mode Sub-table record.

FIG. 5 depicts a known structure for a Virtual Channel Table Section.

FIG. 6 depicts a known structure for a Defined Channels Map.

FIG. 7 depicts a known structure for a Virtual Channels Map.

FIG. 8 depicts a known structure for a Virtual Channel Record.

FIG. 9 is a flowchart depicting exemplary steps for switching from a non-module tuning mode to a module tuning mode in accordance with the present invention.

FIG. 10 is a flowchart depicting alternate exemplary steps for switching from a non-module tuning mode to a module tuning mode in accordance with the present invention.

FIG. 11 in an illustrative depiction of an exemplary user interface in accordance with the present invention.

### DETAILED DESCRIPTION OF THE INVENTION

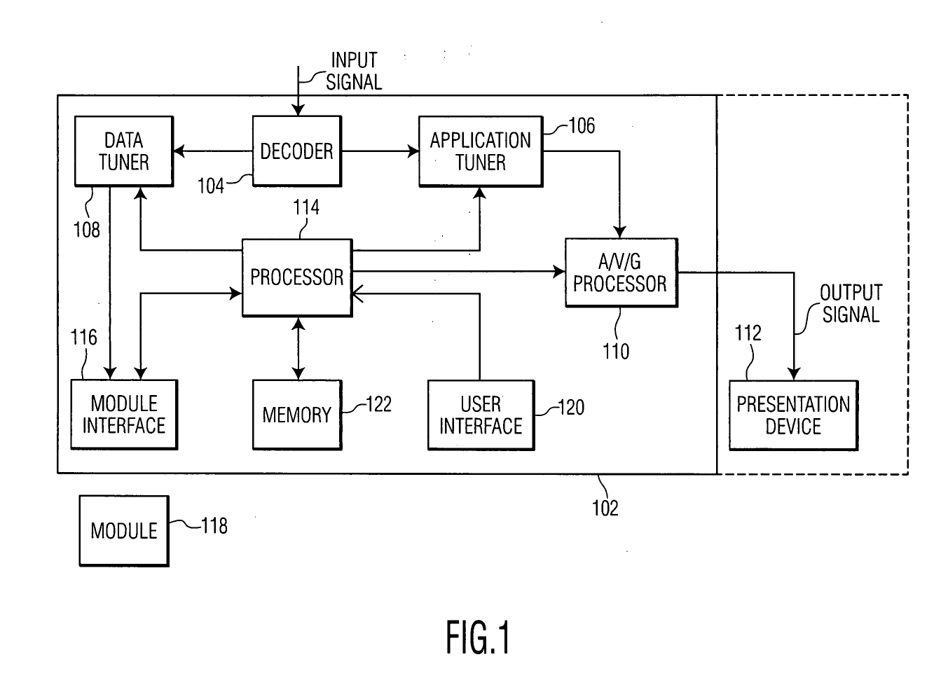

FIG. 1 depicts an exemplary cable television receiver 102 in accordance with the present invention. A cable television system provides a cable television input signal containing multiple signals encoded and multiplexed onto a carrier signal. The input signal is applied to the cable television receiver 102. Within the cable television receiver 102, the input signal is applied to a decoder 104 that decodes and de-multiplexes the input signal into program signals and data signals. The decoder 104 routes the program signals to an application tuner 106 and the data signals to a data tuner 108. The application tuner 106 processes the program signals, which provide services such as audio and video content, and the data tuner 108 processes the data signals, which provide information regarding the available channels of the cable television system. A suitable decoder 104, application tuner 106, and data tuner 108 for use with the present invention will be understood by those of skill in the art.

The programming signals processed by the application tuner 106 are applied to an audio, video, and graphics (A/V/G) processor 110 that generates an output signal for presentation by a presentation device 112 such as a television monitor. In an exemplary embodiment, the presentation device 112 may be separate from the cable television receiver 102, i.e., the cable television receiver 102 may be a set-top box. In an alternative exemplary embodiment, the cable television receiver 102 and the presentation device 112 may be enclosed within a common enclosure (which is indicated by the dashed line extending from the cable television receiver 102 to encompass the presentation device 112). In addition to processing the data signals from the application tuner 106, the A/V/G processor 108 receives data signals from a processor 114. For example, the processor 114 may pass signals to the A/V/G processor 110 for generating a graphic to display on the presentation device 112. A suitable A/V/G processor 110 for use with the present invention will be understood by those of skill in the art.

The data signals processed by the data tuner 108 are applied to a module interface 116. The module interface 116 is coupled to the data tuner 108 and is configured to receive a tuning module 118 compatible with the cable television system. The module interface 116 is further coupled to the processor 114 and includes circuitry configured to generate control signals signaling the processor 114 when the tuning module 118 is present and/or received by the module interface 116.

In an exemplary embodiment, the tuning module 118 is configured to extract system information tables/sub-tables, which are described in further detail below, from the data signals and provide the extracted system information to the processor 114 for processing. The tuning module 118 may be a POD module in accordance with the OPENCABLE™ system of Cable Television Laboratories, Inc., Louisville, Colo., USA.

The processor 114 is configured for communication with the application tuner 106, the data tuner 108, A/V/G processor 110, and the module interface 116. In an exemplary embodiment, a user interface 120, e.g., a keypad and/or wireless receiver, supplies control signals to the processor 114. A memory 122 is coupled to the processor 114 for storing a control program used by the processor 114 to control the cable television receiver 102 in accordance with the present invention. A suitable processor 114 for use with the present invention will be understood by those of skill in the art.

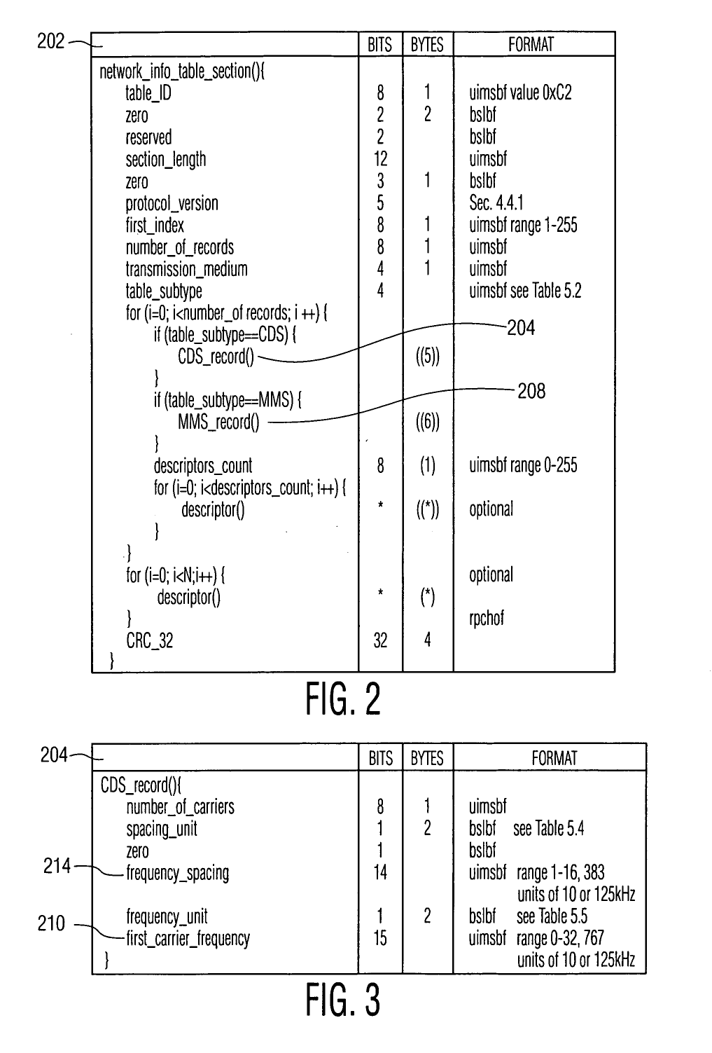

The tables shown in FIGS. 2 through 8 depict the data structures of tables in an exemplary cable television system that enable cable television receivers 102 (FIG. 1) to tune available channels. These structures are disclosed in The Society of Cable Telecommunications Engineers (SCTE) Specification SCTE 65 2002 titled “Service Information Delivered Out-Of-Band for Digital Cable Television”, which is published by The Society of Cable Telecommunications Engineers, 140 Philips Road, Exton, Pa., USA.

FIG. 2 depicts the structure of a Network Information Table 202 that includes references to sub-tables. Specifically, it contains references to a Carrier Definition Sub-table record (CDS_record) 204 and a Modulation Mode Sub-table Record (MMS_record) 208.

FIG. 3 depicts the structure of the Carrier Definition Sub-table record 204, which provides information regarding the actual frequency to be used for a group of channels. The parameter titled “first_carrier_frequency” 210 provides a starting frequency value. The parameter titled “frequency_spacing” 214 provides an incremental value to calculate frequency values subsequent to the starting frequency value.

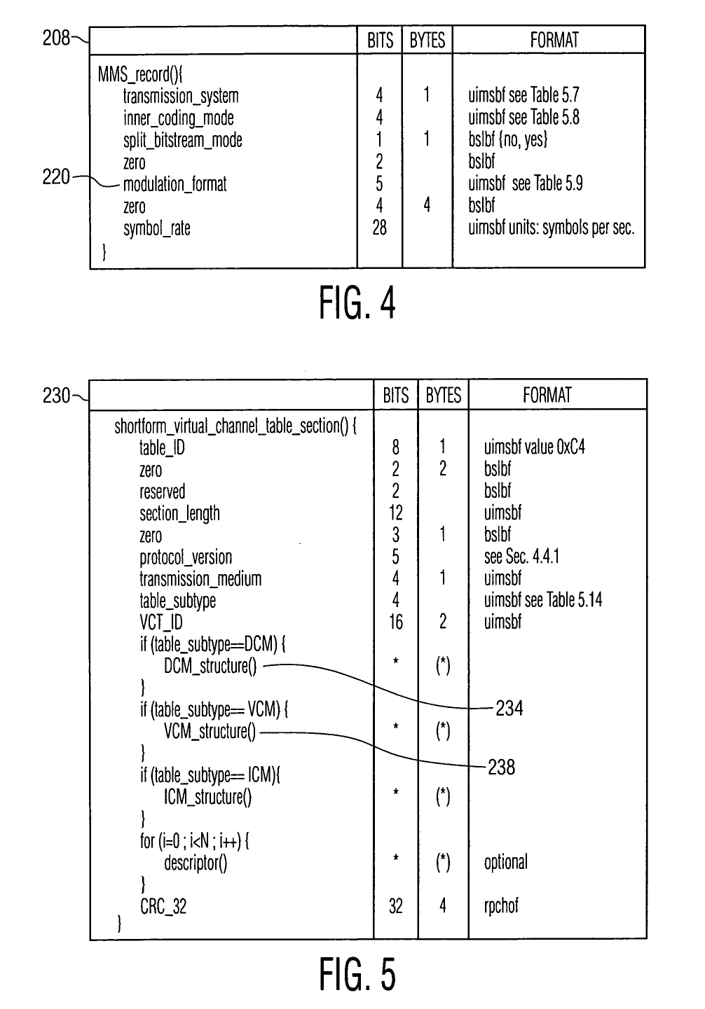

FIG. 4 depicts the structure of the Modulation Mode Sub-table record 208, which provides information regarding the modulation scheme employed. The parameter titled “modulation_format” 220 provides the modulation format. Typical modulation formats, represented by way of non-limiting example, include Quadrature Amplitude Modulation (QAM) modulation schemes (such as QAM64 and QAM256) and Vestigial Side Band (VSB) modulation schemes (such as 8VSB).

FIG. 5 depicts the structure of a Virtual Channel Table Section 230 that contains references to additional sub-tables. The additional sub-tables include a Defined Channel Map (DCM_structure) 234 and a Virtual Channel Map (VCM_structure) 238.

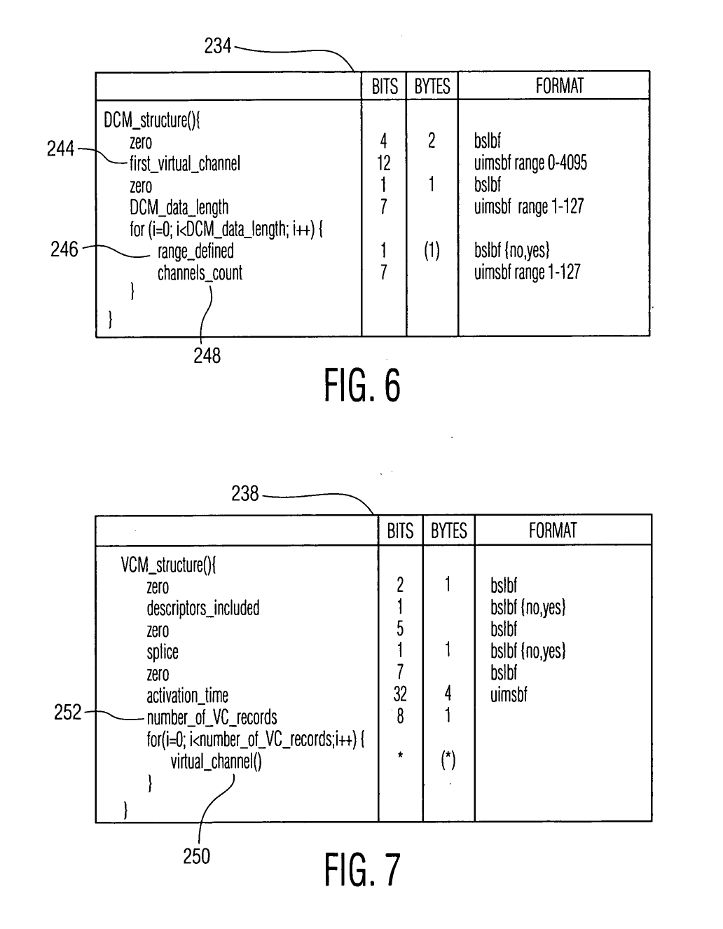

FIG. 6 depicts the structure of the Defined Channels Map 234, which provides information regarding the defined status of a range of channels. A parameter titled “first_virtual_channel” 244 denotes the first channel in the range and a parameter titled “range_defined” 246 indicates the defined status for a defined number of subsequent channels indicated by a parameter titled “channels_count” 248.

FIG. 7 depicts the structure of the Virtual Channel Map (VCM_structure) 238. The Virtual Channel Map 238 references one or more virtual channel records (virtual_channel) 250. A parameter titled “number_of_VC_records” 252 indicates the number of virtual channel records.

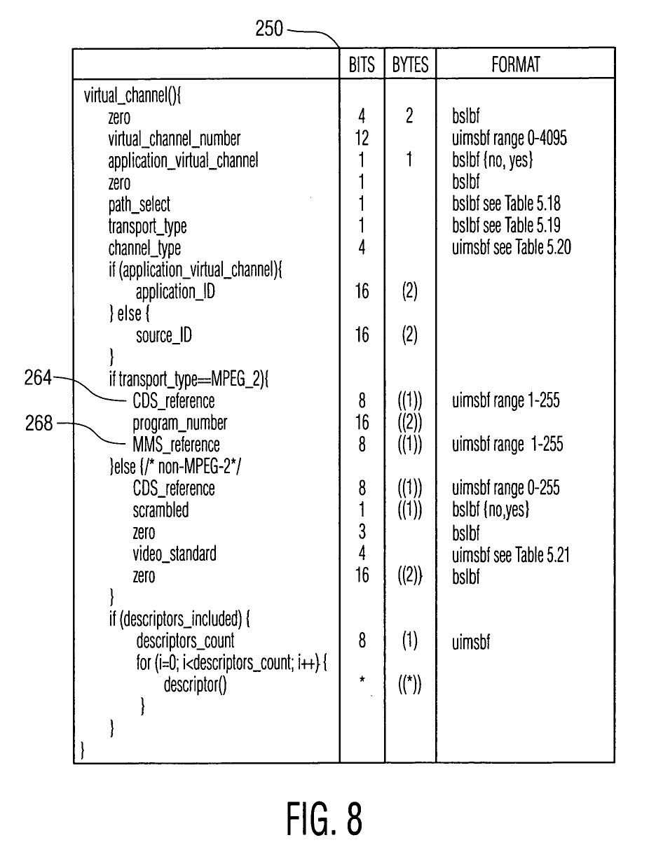

FIG. 8 depicts the structure of a Virtual Channel record 250. The Virtual Channel record 250 includes a parameter titled “CDS_reference” 264, which references an entry in the Carrier Definition Sub-table 204 (FIG. 3). In addition, the Virtual Channel record 250 includes a parameter titled “MMS_reference” 268, which references an entry in the Modulation Mode Sub-table 208 (FIG. 4).

To provide the necessary information needed to access services, such as audio, video, and data, from the cable television system, at least one of each of the following tables/sub-tables is needed:
the Carrier Definition Sub-table 204 (FIG. 3), which defines the actual frequencies of one or more channels;
the Modulation Mode Sub-table 208 (FIG. 4), which defines the modulation scheme for each of the one or more channels;
the Defined Channels Map table 234 (FIG. 6), which defines virtual channels for use in the module tuning mode; and
the Virtual Channels Map table 238 (FIG. 7), which identifies virtual channel records for each of the defined virtual channels, each virtual channel record identifying an actual frequency defined by the Carrier Definition Sub-table and a modulation scheme defined by the Modulation Mode Sub-table.

These tables/sub-tables are referred to herein as critical tables and define all needed parameters, including frequency and modulation mode, to access services (e.g., audio, video, and data) of the cable television system.

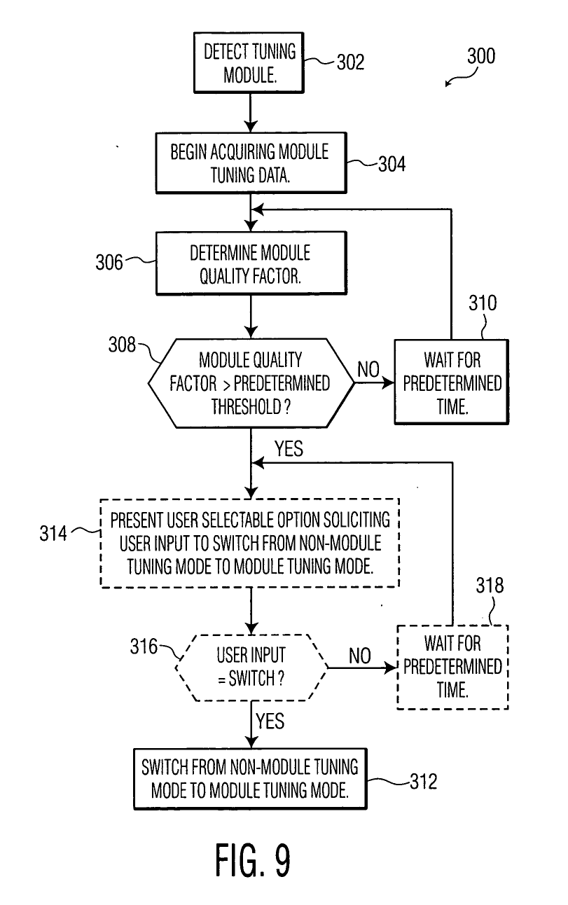

FIG. 9 is a flowchart 300 of exemplary steps for switching a cable television receiver from a non-module tuning mode to a module tuning mode in accordance with the present invention. The exemplary steps are described with reference to the cable television receiver 102 of FIG. 1. At block 302, the processor 114 detects the presence of a cable tuning module 118. In an exemplary embodiment, the module interface 116 generates a signal indicating the presence of the cable tuning module in the module interface and passes the signal to the processor 114 when the cable tuning module is inserted into the module interface or when the power is supplied to the cable television receiver with the cable tuning module in the module interface. This detection may be based on a physical change in the state of signals within the interface or on values retrieved from registers (not shown) of the cable tuning module that identify it as a particular module such as a POD module.

At block 304, the processor 114 acquires module tuning data. In an exemplary embodiment, the module tuning data includes tables and sub-tables (referred to herein as tables) such as those described above with reference to FIGS. 2-8. The processor 114 receives these tables via the cable tuning module 118 and the module interface 116. The tables can arrive at the television receiver 102 for processing by the processor 114 in any order, and may require multiple instances of one or more tables to provide accessibility to the complete range of services from the cable television system. In an exemplary embodiment, the processor 114 acquires module tuning data in response to the detection of the cable tuning module 118 by the module interface 116.

At block 306, a module quality factor is calculated. The module quality factor is based at least in part on the number of channels that are tunable using the acquired module tuning data. A tunable channel is a channel for which all needed parameters, including frequency, modulation mode, and defined status, are available. In an exemplary embodiment, the module quality factor is further based on elapsed time since the cable tuning module was detected and is calculated using the following equation:
MQF=NTC+ET/TSF;
where MQF is the module quality factor, NTC is the number of tunable channels, ET is the elapsed time since the cable tuning module was detected, and TSF is a predefined time scale factor. For example, if the number of tunable channels is 5, the elapsed time is two hours (120 minutes), and the time scale factor is 10 minutes, then the module quality factor is 17 (i.e., 5+120/10=17). In an alternative exemplary embodiment, the module quality factor is based solely on the number of tunable channels or on elapsed time.

At block 308, a decision is made regarding the module quality factor. In an exemplary embodiment, if the module quality factor exceeds a predetermined threshold value, processing proceeds at block 312 or, optionally, at block 314. Otherwise, if the module quality factor does not exceed the predetermined threshold, processing proceeds at block 310. For example, in an exemplary embodiment, if the predetermined threshold is 16, processing will proceed at block 312 (or, optionally, block 314) when the module quality factor is 17 or greater, and will proceed at block 310 is the module quality factor is 16 or less.

In an alternative exemplary embodiment, additional qualifications may be added to proceed to block 312. For example, the number of channels tunable using the cable tuning module may be required to exceed the number of channels tunable without the cable tuning module. In other alternative exemplary embodiments, these additional qualifications may be incorporated into the determination of the module quality factor in block 306.

At block 310, which is reached if the module quality factor does not exceed the predetermined threshold, the television receiver 102 waits to acquire additional tables for a predetermined amount of time, e.g., several seconds or more. Processing then returns to block 306 where the module quality factor is recalculated.

Optionally, in an exemplary embodiment, at block 314, the processor 114 solicits user input to switch from the non-module tuning mode to the module tuning mode. The processor 114 may present a graphic requesting input (referred to herein as a solicitation graphic) on the presentation device 112 via the A/V/G processor 110. At block 316, a decision is made to check if the user has provided input indicating a desire to switch to the non-module tuning mode. The user input may be received at the processor 114 via the user interface 120. If the user indicates a desire to switch to a module tuning mode, processing proceeds at block 312. Otherwise, processing proceeds to block 318 where, the television receiver 102 waits for a predetermined amount of time before proceeding at block 314 to again solicit input. In an exemplary embodiment, the predetermined amount of time may be a half hour or more to avoid too frequent interruption of the user.

In an alternative exemplary embodiment, user input for switching from a non-module tuning mode to a module tuning mode is not solicited. In accordance with this embodiment, blocks 314, 316, and 318, and their corresponding processing steps, may be eliminated.

At block 312, which is reached if the module quality factor exceeds the predetermined threshold as determined at block 308 (and, optionally, if a user indicates a desire to switch tuning modes at block 316), the processor 114 switches the cable television receiver 102 automatically from a non-module tuning mode to a module tuning mode. Thus, the cable television receiver is switched from the non-module tuning mode to the module tuning mode responsive to at least a measure of the acquired module tuning data. Since, in an exemplary embodiment, the module quality factor increases with time, even if no tunable channels are found, the cable television receiver 102 will eventually switch to the module tuning mode regardless of the number of tunable channels.

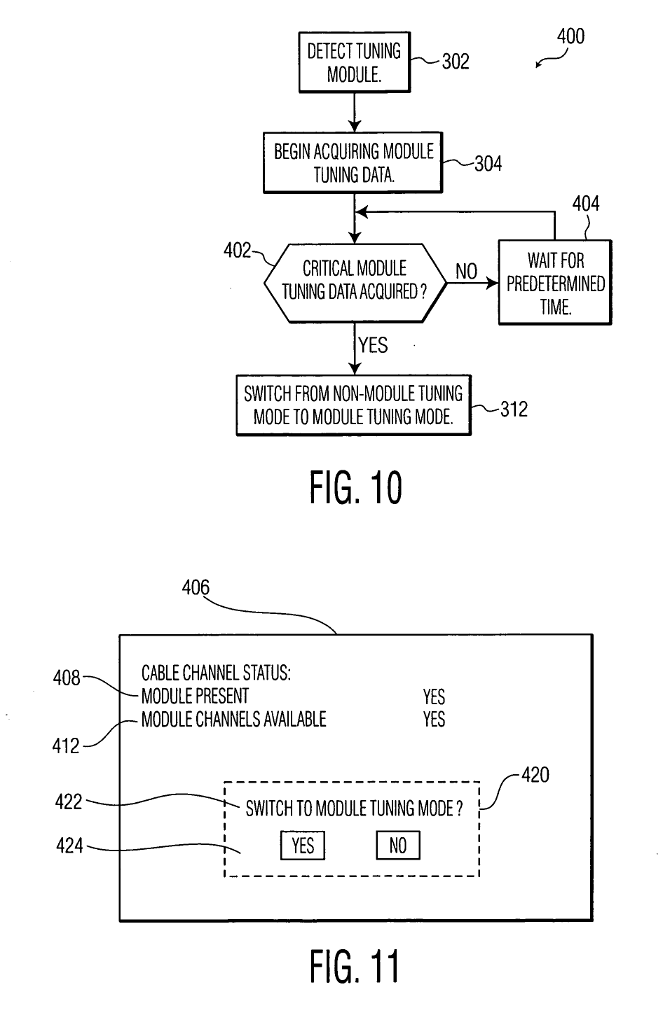

FIG. 10 is a flowchart 400 of alternative exemplary steps for switching from the non-module tuning mode to the module tuning mode in accordance with the present invention. Steps within flow chart 400 that are identical to steps within flow chart 300 (FIG. 9) have the same reference numerals with details not being repeated. At block 302, the processor 104 detects the presence of a cable tuning module. At block 304, the processor begins acquiring module tuning data.

At block 402, a decision is made to determine if critical module tuning data has been acquired. In an exemplary embodiment, the critical module tuning data is data needed to tune at least one channel, e.g., at least one table of each of the critical tables, as described above with reference to FIGS. 2-8. If critical module tuning data is acquired, processing proceeds at block 312. Otherwise, processing proceeds at block 404.

At block 404, which is reached if critical module tuning data is not yet acquired, the television receiver 102 waits to acquire additional module tuning data for a predetermined amount of time, e.g., several seconds or more. Processing then returns to block 402 where the decision regarding critical module tuning data is made again.

At block 312, which is reached if it is determined that the critical module tuning data has been acquired at block 402, the processor 114 switches the television receiver 102 from the non-module tuning mode to the module tuning mode. This embodiment provides the advantages of a simpler implementation, and a potentially faster switching time. By switching faster, however, less time is available to acquire the needed information for full access of the services available on the cable television system. Those of skill in the art will understand that the steps described in blocks 314, 316, and 318 of flow chart 300 with reference to FIG. 9 can be incorporated into the steps of flow chart 400 immediately preceding step 312.

FIG. 11 is an illustration of an exemplary information graphic 406 indicating the current module tuning mode. This graphic may be displayed to a user on the presentation device 112, e.g., automatically or in response to a user input received via the user interface 120. The information graphic 406 may be generated by the processor 114 (FIG. 1) and presented on the presentation device 112 via the A/V/G processor 110.

The exemplary information graphic 406 provides a module presence indicator 408 indicating the presence of the cable tuning module, and a module status indicator 412 indicating if the cable television receiver has switched to the module tuning mode. In the illustrated embodiment, the word “YES” following the phrase “POD CABLE CHANNELS AVAILABLE” signifies that the cable television receiver is in the module tuning mode, and the word “NO” (not shown) would signify that the cable television receiver is in the non-module tuning mode.

In the illustrated embodiment, the information graphic 406 includes a solicitation graphic 420. The solicitation graphic 420 may be used to solicit input from a user/viewer. The illustrated solicitation graphic 420 includes text 422 presenting a question to the user, e.g., questioning if the user wants to “Switch to Module Tuning Mode?.” The user is provided with user selectable buttons 424 that may be selected by the user with a remote control via the user interface 120 (FIG. 1), for example. Using the user selectable buttons 424, a user is able to provide input to select whether they want to switch to the module tuning mode, e.g., selecting “YES” to switch and “NO” not to switch.

Hypothetical channel information for examples which follow is provided in Table 1.

TABLE 1

| Physical Channel | Frequency | Modulation | Virtual Channel |
|---|---|---|---|
| 70 | 501 MHz | Analog | 70 |
| 72 | 513 MHz | Analog | 80 |
| 73 | 519 MHz | Analog | 19 |
| 90-1 | 621 MHz | 64-QAM | 91 |
| 90-2 | 621 MHz | 64-QAM | 92 |
| 114-1 | 735 MHz | 256-QAM | 6-1 |

Referring now to the columns of the data in Table 1 from left to right, the first column represents the physical channel number, the second column represents the channel frequency for a corresponding physical channel, the third column represents the corresponding modulation type, and the fourth column represents a corresponding virtual channel number assigned by the cable television system. In this exemplary data, digital broadcasts are shown in a compound number format for the physical channel number, e.g., 114-1. The major number (e.g., 114) correlates to the frequency of the major channel, and the minor number (e.g., 1) correlates to the particular MPEG program within a multi-program bit stream transmitted at that frequency.

In use, referring back to FIG. 1, the cable television receiver 102 is first connected to receive the input signal from the cable television system without a cable tuning module 118. Thus, the television receiver 102 is in a non-module tuning mode and determines channels for viewing by tuning to various frequencies and determining the existence of a valid television signal at those frequencies. For example, assume a cable television system provides the physical channels shown in Table 1. In the non-module tuning mode, the list of channels available to the user would be based on the physical channel. Therefore, the user would see the channel numbers 70, 72, 73, 90-1, 90-2, and 114-1. Once the cable tuning module 118 is inserted, the television receiver 102 begins to acquire module tuning data (e.g., tables) in step 304 of FIG. 9 and FIG. 10. In the embodiment described with reference to FIG. 9, the module tuning data is monitored to determine how many channels are viewable while taking into account the elapsed time to acquire these tables. Once sufficient data has been acquired, or enough time has elapsed, the cable television receiver switches to the module tuning mode. In the embodiment described with reference to FIG. 10, upon acquiring critical data (e.g., a first instance of each critical table), the cable television receiver switches to the module mode.

In the module tuning mode, the channels available to the user are represented by the virtual channels, i.e., the channels in the far right column. Therefore, the user would see channels 70, 80, 19, 91, 92, and 6-1. The television receiver may present these channels reordered such that the virtual channel numbers increase as the user changes channels in the “up” direction, and the channel numbers decrease when changing channels in the “down” direction.

Note that the virtual number can be the same number as the physical number. For example, channel 70 has the same value for both the physical channel and the virtual channel. It is common practice in cable television systems, however, to use different numbers for the virtual channel. In this case, this invention can provide the user with an indication that the channel has been updated to reflect the virtual channel designation. For example, assume a user is watching physical channel 73 with a cable television receiver 102 (FIG. 1) operating in the non-module tuning mode. After a cable tuning module is inserted into the television receiver, the television receiver switches to the module tuning mode after acquiring module tuning data in accordance with the present invention. Since the virtual channel corresponding to the physical channel 73 at 519 MHz is 19, the television receiver can update an on-screen display presented on the presentation device 112 to reflect that channel 73 is now known as channel 19 while continuing to present the audio/video content of physical channel 73. Thus, the programming being presented to the viewer is not interrupted.

The present invention provides the advantages of allowing a cable television receiver 102 to continue tuning channels in a non-module tuning mode after a module is inserted and then switch to the module tuning mode based on acquired module tuning data. Accordingly, the cable television receiver is able to remain in the non-module tuning mode, initially, when channel selection in the module tuning mode may be inferior to channel selection in the non-module tuning mode. The cable television receiver may then switch to the module tuning mode when channel selection in the module tuning mode improves. In addition, the present invention enables a viewer to continue viewing channels that have been tuned to prior to the insertion of the cable tuning module even when switching from non-module tuning mode to module tuning mode.

Although the invention has been described in terms of a decoder 104, data tuner 108, application tuner 106, processor 114, and A/V/G processor 110, it is contemplated that the invention may be implemented in software on a computer (not shown). In this embodiment, one or more of the functions of the various components may be implemented in software that controls the computer. This software may be embodied in a computer readable carrier, for example, a magnetic or optical disk, a memory-card or an audio frequency, radio-frequency, or optical carrier wave.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method for use in a cable television receiver to switch from a non-module tuning mode to a module tuning mode, the method comprising the steps of:
detecting a cable tuning module in the cable television receiver;
acquiring module tuning data responsive to the detection of the cable tuning module; and
switching from the non-module tuning mode to the module tuning mode responsive to a measure of the acquired module tuning data.

2. The method of claim 1, wherein the switching step comprises the steps of:
determining if the acquired module tuning data enables the cable television receiver to tune at least a predetermined number of channels; and
switching from the non-module tuning mode to the module tuning mode when the cable television receiver is able to tune at least the predetermined number of channels.

3. The method of claim 1, wherein the cable television receiver is configured to tune channels for viewing by a user and wherein the switching step comprises the steps of:
determining if the acquired module tuning data enables the cable television receiver to tune at least a predetermined number of channels;
soliciting user input to switch from the non-module tuning mode to the module tuning mode when the cable television receiver is able to tune at least the predetermined number of channels; and
switching from the non-module tuning mode to the module tuning mode responsive to the solicited user input.

4. The method of claim 1, wherein the switching step comprises the steps of:
calculating a module quality factor based at least in part on a number of channels that may be tuned using the acquired module tuning data; and
switching from the non-module tuning mode to the module tuning mode automatically responsive to the module quality factor having a value greater than a threshold value.

5. The method of claim 4, wherein the module quality factor equals:
NTC+ET/TSF;
where NTC is the number of channels that may be tuned based on the acquired module tuning data, ET is elapsed time since the cable tuning module was detected, and TSF is a time scale factor.

6. The method of claim 1, wherein the acquiring step comprises the step of:
acquiring a first instance of each table within a set of critical tables, the set of critical tables enabling the tuning of at least one channel; and
wherein the switching step comprises the step of:
switching from the non-module tuning mode to the module tuning mode responsive to the acquisition of the first instance of each table within the set of critical tables.

7. The method of claim 6, wherein the step of acquiring the first instance of each table within the set of critical tables comprises the steps of:
acquiring a Carrier Definition Sub-table, the Carrier Definition Sub-table defining actual frequencies of one or more channels;
acquiring a Modulation Mode Sub-table, the Modulation Mode Sub-table defining modulation schemes for the one or more channels;
acquiring a Defined Channels Map table, the Defined Channels Map defining one or more virtual channels for use by the cable television receiver when in the module tuning mode; and
acquiring a Virtual Channels Map table, the Virtual Channels Map table identifying a virtual channel record for each of the defined virtual channels, each virtual channel record identifying an actual frequency defined by the Carrier Definition Sub-table and a modulation scheme defined by the Modulation Mode Sub-table.

8. The method of claim 1, further comprising the step of:
presenting a virtual channel reference number corresponding to a currently tuned physical channel responsive to switching from the non-module tuning mode to the module tuning mode.

9. The method of claim 1, further comprising the step of:
tuning to a virtual channel corresponding to a previously tuned physical channel responsive to switching from the non-module tuning mode to the module tuning mode.

10. A cable television receiver apparatus comprising:
a module interface configured to receive a cable tuning module; and
a processor coupled to the module interface; the processor configured to detect a module inserted in the module interface, acquire module tuning data from the module responsive to the detection of the module, and switch from a non-module tuning mode to a module tuning mode responsive to a measure of the acquired module tuning data.

11. The apparatus of claim 10, wherein the processor is further configured to determine if the acquired module tuning data enables at least a predetermined number of channels to be tuned and switches from the non-module tuning mode to the module tuning mode when the cable television receiver is able to tune at least the predetermined number of channels.

12. The apparatus of claim 10, further comprising:
a presentation device coupled to the processor that presents a solicitation graphic soliciting user input to switch from the non-module tuning mode to the module tuning mode;
wherein the processor is further configured to tune channels for viewing by a user, determine if the acquired module tuning data enables at least a predetermined number of channels to be tuned, and present the user with the solicitation graphic when the processor is able to tune at least the predetermined number of channels and wherein the processor switches from the non-module tuning mode to the module tuning mode responsive to the solicited user input.

13. The apparatus of claim 10, wherein the processor is further configured to calculate a module quality factor based at least in part on a number of channels that may be tuned using the acquired module tuning data and switches from the non-module tuning mode to the module tuning mode automatically responsive to the module quality factor having a value greater than a threshold value.

14. The apparatus of claim 13, wherein the module quality factor equals:
NTC+ET/TSF;
where NTC is the number of channels that may be tuned based on the acquired module tuning data, ET is elapsed time since the cable tuning module was detected, and TSF is a time scale factor.

15. The apparatus of claim 10, wherein the processor is configured to acquire a first instance of each table within a set of critical tables, the set of critical tables enabling the tuning of at least one channel, and the processor switches from the non-module tuning mode to the module tuning mode responsive to the acquisition of the first instance of each table within the set of critical tables.

16. The apparatus of claim 15, wherein the set of critical tables comprises:
a Carrier Definition Sub-table, the Carrier Definition Sub-table defining actual frequencies of one or more channels;
a Modulation Mode Sub-table, the Modulation Mode Sub-table defining modulation schemes for the one or more channels;
a Defined Channels Map table, the Defined Channels Map defining one or more virtual channels for use by the cable television receiver when in the module tuning mode; and
a Virtual Channels Map table, the Virtual Channels Map table identifying a virtual channel record for each of the defined virtual channels, each virtual channel record identifying an actual frequency defined by the Carrier Definition Sub-table and a modulation scheme defined by the Modulation Mode Sub-table.

17. The apparatus of claim 10, further comprising:
a presentation device coupled to the processor;
wherein the processor is configured to present a virtual channel reference number on the presentation device corresponding to a currently tuned physical channel responsive to switching from the non-module tuning mode to the module tuning mode.

18. The apparatus of claim 10, wherein the processor is configured to tune to a virtual channel corresponding to a previously tuned physical channel responsive to switching from the non-module tuning mode to the module tuning mode.

19. A system for use in a cable television receiver to switch from a non-module tuning mode to a module tuning mode, the system comprising:
means for detecting a cable tuning module in the cable television receiver;
means for acquiring module tuning data responsive to the detection of the s cable tuning module; and
means for switching from the non-module tuning mode to the module tuning mode responsive to a measure of the acquired module tuning data.

20. The system of claim 19, wherein the switching means comprises:
means for determining if the acquired module tuning data enables the cable television receiver to tune at least a predetermined number of channels; and
means for switching from the non-module tuning mode to the module tuning s mode when the cable television receiver is able to tune at least the predetermined number of channels.

21. The system of claim 19, wherein the cable television receiver is configured to tune channels for viewing by a user and wherein the switching means comprises:
means for determining if the acquired module tuning data enables the cable television receiver to tune at least a predetermined number of channels;
means for soliciting user input to switch from the non-module tuning mode to the module tuning mode when the cable television receiver is able to tune at least the predetermined number of channels; and
means for switching from the non-module tuning mode to the module tuning mode responsive to the solicited user input.

22. The system of claim 19, wherein the switching means comprises:
means for calculating a module quality factor based at least in part on a number of channels that may be tuned using the acquired module tuning data; and
means for switching from the non-module tuning mode to the module tuning mode automatically responsive to the module quality factor having a value greater than a threshold value.

23. The system of claim 19, wherein the acquiring means comprises:
means for acquiring a first instance of each table within a set of critical tables, the set of critical tables enabling the tuning of at least one channel; and
wherein the switching means comprises:
means for switching from the non-module tuning mode to the module tuning mode responsive to the acquisition of the first instance of each table within the set of critical tables.

24. The system of claim 19, further comprising:
means for presenting a virtual channel reference number corresponding to a currently tuned physical channel responsive to switching from the non-module tuning mode to the module tuning mode.

25. The system of claim 19, further comprising:
means for tuning to a virtual channel corresponding to a previously tuned physical channel responsive to switching from the non-module tuning mode to the module tuning mode.

26. A computer readable carrier including software that is configured to control a computer to implement a method embodied in a computer readable medium for use in a cable television receiver to switch from a non-module tuning mode to a module tuning mode, the method including the steps of:
detecting a cable tuning module in the cable television receiver;
acquiring module tuning data responsive to the detection of the cable tuning module; and
switching from the non-module tuning mode to the module tuning mode responsive to a measure of the acquired module tuning data.

27. The computer readable carrier of claim 26, wherein the switching step for implementation by the computer comprises the step of:
determining if the acquired module tuning data enables the cable television receiver to tune at least a predetermined number of channels; and
switching from the non-module tuning mode to the module tuning mode when the cable television receiver is able to tune at least the predetermined number of channels.

28. The computer readable carrier of claim 26, wherein the cable television receiver is configured to tune channels for viewing by a user and wherein the switching step for implementation by the computer comprises the step of:
determining if the acquired module tuning data enables the cable television receiver to tune at least a predetermined number of channels;
soliciting user input to switch from the non-module tuning mode to the module tuning mode when the cable television receiver is able to tune at least the predetermined number of channels; and
switching from the non-module tuning mode to the module tuning mode responsive to the solicited user input.

29. The computer readable carrier of claim 26, wherein the switching step for implementation by the computer comprises the step of:
calculating a module quality factor based at least in part on a number of channels that may be tuned using the acquired module tuning data; and
switching from the non-module tuning mode to the module tuning mode automatically responsive to the module quality factor having a value greater than a threshold value.

30. The computer readable carrier of claim 29, wherein the calculating step for implementation by the computer comprises the step of:
calculating NTC+ET/TSF;
where NTC is the number of channels that may be tuned, ET is elapsed time since the cable tuning module was detected, and TSF is a time scale factor.

31. The computer readable carrier of claim 26, wherein the acquiring step for implementation by the computer comprises the step of:
acquiring a first instance of each table within a set of critical tables, the set of critical tables enabling the tuning of at least one channel; and
wherein the switching step for implementation by the computer comprises the step of:
switching from the non-module tuning mode to the module tuning mode responsive to the acquisition of the first instance of each table within the set of critical tables.

32. The computer readable carrier of claim 26, wherein the method implemented by the computer further includes the step of:
presenting a virtual channel reference number corresponding to a currently tuned physical channel responsive to switching from the non-module tuning mode to the module tuning mode.

33. The computer readable carrier of claim 26, wherein the method implemented by the computer further includes the step of:
tuning to a virtual channel corresponding to a previously tuned physical channel responsive to switching from the non-module tuning mode to the module tuning mode.
